(19) United States
(12) Patent Application Publication
(10) Pub. No.: US 2024/0307820 A1
(43) Pub. Date: Sep. 19, 2024

(54) SOLVENT-BASED CO2 CAPTURE PROCESS INCORPORATING OVERHEAD VAPOR COMPRESSION

(71) Applicant: UOP LLC, Des Plaines, IL (US)

(72) Inventors: Scott L. Nauert, Chicago, IL (US); Carl J. Stevens, Deerfield, IL (US); Jeffrey A. Tyska, Roselle, IL (US); Nikunj Prataprai Tanna, Gurugram (IN); Michael R. Van de Cotte, Palatine, IL (US)

(21) Appl. No.: 18/588,217

(22) Filed: Feb. 27, 2024

Related U.S. Application Data
(60) Provisional application No. 63/490,577, filed on Mar. 16, 2023.

(51) Int. Cl. B01D 53/34; B01D 53/14

(52) U.S. Cl. CPC B01D 53/343; B01D 53/1431; B01D 53/1475; B01D 2257/504; B01D 2258/0283; B01D 2259/65

(57) ABSTRACT

Processes for solvent-based CO₂ capture are described. The processes incorporate overhead vapor compression which increases the condensation temperature of water in the CO₂ stripper allowing for recovery of the latent heat of the water vapor to be recovered. The processes utilize a CO₂ stripping column, a compressor in the column total overhead, and a heat exchanger exchanging heat between the compressed total overhead and a portion of the rich solvent.

### RELATED APPLICATIONS

This application claims priority to U.S. Provisional Patent Application Ser. No. 63/490,577, filed on Mar. 16, 2023, the entirety of which is incorporated herein by reference.

### BACKGROUND

Environmental concerns have led to efforts to reduce the amount of CO₂ released from major CO₂ sources such as power plants, refineries, and others industrial processes. The goal of these processes is to reduce customer CO₂ emissions through carbon capture and utilization or storage (CCUS).

Among the processes used for post-combustion CO₂ capture are solvent-based CO₂ absorption processes to remove CO₂ from flue gas streams. There are a variety of solvent-based absorption processes. In general, the flue gas is contacted with a solvent which removes the CO₂ from the flue gas stream, with the purified flue gas exiting from the top of the absorber column and the rich solvent stream exiting at or near the bottom of the absorber column. The rich solvent stream is sent to a stripping column where heat is input to remove the CO₂ from the solvent, forming an overhead CO₂ stream and a lean solvent stream. The overhead CO₂ stream can be further processed to remove impurities. The overhead CO₂ stream can be further compressed to a pressure suitable for injection to a pipeline. The overhead CO₂ stream can be compressed and liquefied for transport or storage.

Some of the heat vaporizes water from the solvent, and the heat used to vaporize water is not productive. It would be desirable to recover the heat from the stripping column overhead stream to reduce the column reboiler or other heat duty.

In a process using a simple stripping column, an overhead condenser condenses the vaporized water and returns it to the stripping column as reflux. This process loses all heat from the vaporized water. Another process involves the use of a flash stripper, as described in U.S. Pat. No. 9,956,505, which is incorporated herein by reference in its entirety. This process does not use a stripper reboiler. Instead, the heat is supplied by a heater, such as a convective steam heater, upstream of the stripping column. The overhead CO₂ stream is heat exchanged with the rich solvent stream from the absorber, condensed to remove water, and compressed. Some waste heat (e.g., about 40-50% of the water latent heat of vaporization) is recovered in the CO₂ heat exchanger. The rest of the heat is lost because the temperature at which the heat is available drops below the process pinch point temperature at which point it is no longer useful.

One challenge with both the simple stripping process and the flash stripping process is that they require process heat in the stripping column reboiler or stripping column steam heater to remove CO₂ from the solvent. This process heat is typically provided by steam which is generated by burning natural gas or coal in a power plant or by burning natural gas in a separate boiler. In the case of the flash stripping process with steam generated by burning natural gas in a separate boiler, this produces between 0.15-0.2 kg CO₂ per CO₂ captured from the feed. CO₂ from the boiler can be captured in the process, but this increases the overall size of the plant and increases transport and storage costs. Additionally, it may not be desirable in some situations to generate additional CO₂ in the process of capturing CO₂ from the feed source.

Another issue involves the necessity of large amounts of cooling water for the process. Fresh water is becoming a very precious resource. Because the process temperatures needed are lower than can be reasonably achieved with air cooling, cooling water is required. Flash stripping requires a large amount of process cooling (e.g., on the order of 500 MMBTU/h cooling to capture 1 million MT CO₂/yr from an FCC plant). Providing this amount of cooling water may be difficult in locations where there is a current or potential future restriction on the availability of water.

Therefore, there is a need for a carbon capture process having a lower heat input requirement and/or a reduced cooling water requirement.

### BRIEF DESCRIPTION OF THE DRAWINGS

FIG. 1 is an illustration of one embodiment of a flash stripping process according to the present invention.

FIG. 2 is an illustration of another embodiment of a flash stripping process according to the present invention.

FIG. 3 is an illustration of another embodiment of a flash stripping process according to the present invention.

FIG. 4 is an illustration of another embodiment of a flash stripping process according to the present invention.

FIG. 5 is an illustration of another embodiment of a flash stripping process according to the present invention.

FIG. 6 is an illustration of another embodiment of a flash stripping process according to the present invention.

FIG. 7 is an illustration of another embodiment of a flash stripping process according to the present invention.

FIG. 8 is an illustration of another embodiment of a flash stripping process according to the present invention.

FIG. 9 is an illustration of another embodiment of a flash stripping process according to the present invention.

FIG. 10 is an illustration of another embodiment of a flash stripping process according to the present invention.

FIG. 11 is an illustration of another embodiment of a flash stripping process according to the present invention.

FIG. 12 is an illustration of a flash stripping process without overhead compression.

### DESCRIPTION OF THE INVENTION

The present invention solves this problem by increasing the condensation temperature of water in the CO₂ stripper overhead above the process pinch temperature such that 90% or more of the water vapor latent heat can be recovered. The recovered heat is used to heat a portion of the feed, lowering the stripper net heater duty by 17% compared to the advanced flash stripper from 2.5 GJ/MT CO₂ captured to 2.07 GJ/MT CO₂ captured. The net heater duty energy savings are even higher compared to the simple stripper. The process pinch temperature is the point of closest temperature approach between the process hot and cold composite curves.

The stripper net heater duty is an important metric for solvent-based plant technologies for CO₂ capture. The proposed invention decreases heat usage in exchange for higher electricity usage. Electricity is currently easier to decarbonize than heat, so a process with more electricity and less heat may have a lower global warming potential which is valuable when the point of the plant is CO₂ capture. The process scheme also has 3% lower equivalent work than the advanced flash stripper.

One alternative is to use lean vapor compression (LVC) of the lean solvent. In this scheme, lean solvent is flashed to low pressure, releasing CO₂ and additional steam, and the CO₂ and steam are compressed and sent back to the CO₂ stripper to lower the net reboiler duty. LVC decreases heat demand in exchange for higher electrical duty similar to the proposed invention. However, LVC does not reduce reboiler duty or equivalent work as much as the current invention. For reference, Lin and Rochelle found that LVC reduces reboiler duty by 8% and equivalent work by 3% compared to the simple stripper for 8m PZ solvent (Lin, Y-J; Rochelle, G. T., “Approaching a Reversible Stripping Process for CO₂ Capture”, Chem. Eng. Journal, 2016, 283, 1033-1043).

The invention relates to an advanced solvent carbon capture (ASCC) system. It provides an alternative to LVC for reducing net reboiler duty for lower equivalent work cost while maintaining high stripper pressure which is a key advantage for the ASCC process.

The invention utilizes a CO₂ stripping column, a compressor in the column total overhead, and a heat exchanger exchanging heat between the compressed total overhead and a portion of the rich solvent. This invention can be practiced in conjunction with the advanced flash stripper.

Compressing the stripping column total overhead can be undesirable if it adds additional equipment for a compressor. In some embodiments, the invention can combine the overhead compressor with a downstream CO₂ compressor on a common driver. In some embodiments, multiple overhead compressors are combined with a downstream CO₂ compressor on a common driver.

The stripping column total overhead temperature may be greater than 100° C. at the suction of the overhead compressor. After compression, the discharge temperature may be great than 200° C. Dry gas seals have lower leakage rates than other types of seals which may make them advantageous, but they have temperature limitations which may make them unsuitable. Other types of seals such as carbon ring seals have higher temperature limits but higher leakage rates. Traditional centrifugal compressors can only use one type of seal in the machine. In some embodiments, the overhead compressor is an integrally geared compressor to better match the compressor seals in each stage of the overhead compressor.

There may be a difference in volumetric flow rate of the stripping column total overhead and the downstream CO₂ compressor which leads to a mismatch in impeller speed and size if a centrifugal compressor with a common driver is used. In some embodiments, the overhead compressor is an integrally geared compressor to best match the impeller speed and size for each stage of overhead compression and CO₂ compression.

For very large CO₂ capture rates or low stripping column pressure, the overhead vapor volumetric flow rate may be high enough such that an undesirably large compressor frame size is required for overhead compression. In some embodiments, the overhead compressor is a double-flow inlet compressor to reduce the frame size.

The flue gas stream and a lean solvent stream are introduced into the absorber column where the CO₂ is absorbed into an absorbent. Any suitable absorbent can be used as is known in the art. Suitable absorbents include, but are not limited to potassium carbonate, monoethanolamine, diethanolamine, methyldiethanolamine, piperazine, 2-methylpiperazine, amino-2-methyl-1-propanol, or combinations thereof.

Amine solvents have non-zero vapor pressure which can result in undesirable loss of solvent into the flue gas stream and acid gas stream. The absorber column and stripping column may have a water wash section to reduce solvent loss as is well known in the art. The water wash section may be located at the top of the column, or it may be a separate column downstream of the absorber column or stripping column. A single water wash section may not reduce solvent loss in the flue gas or acid gas to sufficient levels for high vapor pressure amine solvents. The absorber column and stripping column may have a two-stage water wash section or an acid wash section as known in the art.

The purified flue gas stream exits at the top of the absorber column and the rich solvent stream exits from the bottom. A “purified” flue gas stream has a lower level of CO₂ than the incoming gas stream. A “rich solvent” stream is any stream that contains more CO₂ than the “lean solvent” stream from the stripping column.

The heated rich solvent stream is sent to the stripping column where the CO₂ is separated from the solvent. The CO₂ exits in an overhead stream, and the lean solvent exits at or near the bottom of the stripping column. The lean solvent stream is returned to the absorber column.

In more detail, a compressor is placed in the overhead of the CO₂ stripper, and the stripper total overhead is compressed with a pressure ratio P/P0 greater than 1.5, or greater than 1.6, or greater than 1.7, or more than 1.8. Heat is then exchanged between the compressed total overhead and a portion of the rich solvent in a heat exchanger to heat a portion of the rich solvent entering the CO₂ stripper. Heat can be exchanged between the compressed total overhead and any portion of the rich solvent stream, including but not limited to rich solvent bypass taken before the lean/rich exchanger, warm solvent bypass after the lean/rich exchanger (for simple stripper configuration), warm solvent bypass after the cold cross exchanger (Advanced Flash Stripper), or hot rich bypass taken after the hot cross exchanger (Advanced Flash Stripper). The portion of rich solvent heated against the compressed total overhead stream is then fed to the CO₂ stripping column at an appropriate feed point at the top of the column, the column sump, or an intermediate point in the column. An intermediate feed location is preferred, followed by the column sump and finally the top of the column. In one instance of the invention, a once-through convective steam heater is used to provide the remaining heat duty for the column. In another instance, a circulating or kettle reboiler is used to provide the remaining heat for the column.

One aspect of the invention is a process for CO₂ recovery from flue gas. In one embodiment, the process comprises introducing a flue gas stream and a cooled lean solvent stream into an absorber column forming a purified flue gas stream and a rich solvent stream comprising CO₂. The rich solvent stream is directed through at least a cold heat exchanger followed by a hot heat exchanger, and a lean solvent stream from a stripping column is directed through the hot heat exchanger followed by the cold heat exchanger forming a heated rich solvent stream and the cooled lean solvent stream. All or a portion of the heated rich solvent stream is delivered to the stripping column. The solvent is separated from the CO₂ in the stripping column, forming a lean solvent stream and an overhead stream. The overhead stream is compressed forming a compressed overhead stream. A warm rich bypass stream is separated from the rich solvent stream downstream of the cold heat exchanger and upstream of the hot heat exchanger. The compressed overhead stream is contacted with all or a portion of the warm rich bypass stream in a warm rich bypass overhead heat exchanger forming a heated warm rich bypass stream and a cooled compressed overhead stream. The heated warm rich bypass stream is directed to the stripping column.

A “rich solvent” stream is any solvent stream that contains more CO₂ than the “lean solvent” stream from the stripping column on a per unit mass basis.

The purified flue gas stream has a reduced level of CO₂ compared to the incoming flue gas stream. The CO₂ in the purified flue gas stream may be reduced by greater than 70%, or greater than 80%, or greater than 85%, or greater than 90%, or greater than 95% on a mass basis.

The heat exchanger type for the compressed overhead/rich solvent heat exchange is not limited, and any suitable heat exchangers can be used. Suitable heat exchangers include, but are not limited to, a TEMA type shell-and-tube exchanger, a gasketed plate-and-frame heat exchanger, or a welded plate-and-frame heat exchanger.

The overhead compressor type is not limited, and any suitable compressor can be used. Suitable compressors include, but are not limited to, reciprocating compressors, axial compressors, or centrifugal compressors. The overhead compressor may have a suction drum installed at the inlet to prevent liquid carryover from the column to the compressor in the event of heat loss or a process upset. Standard practices are applied to prevent condensation between the suction drum and the compressor inlet.

The heated cold rich bypass stream and the heated warm rich bypass stream will typically be introduced into the stripping column at a point higher in the column than the heated rich solvent stream. The heated cold rich bypass stream will typically be introduced into the stripping column at a point higher in the column than and the heated warm rich bypass stream. The warm rich bypass stream will typically be introduced into the stripping column at a point higher in the column than the heated warm rich bypass stream.

Two or more of the solvent rich streams may be combined before being sent to the stripping column. For example, the heated rich solvent stream and heated warm rich bypass stream may be combined, or the heated cold rich bypass stream and the warm rich bypass stream, or the heated cold rich bypass stream and the heated warm rich bypass stream.

The warm rich bypass stream may be divided into a first portion and a second portion, with the second portion of the warm rich bypass stream being directed to the stripping column.

A cold rich bypass stream may be separated from the rich solvent stream upstream of the cold heat exchanger. The cold rich bypass stream and the cooled compressed overhead stream may be directed through a CO₂ heat exchanger forming a heated cold rich bypass stream and a second cooled compressed overhead stream. The heated cold rich bypass stream may be directed to the stripping column. Water may be condensed from the second cooled compressed overhead stream.

The warm rich bypass stream may be divided into a first portion and a second portion. The second portion of the warm rich bypass stream and the heated cold rich bypass stream may be combined forming a combined stream, and the combined stream may be directed to the stripping column.

The heated rich solvent may be heated in a steam heater or an additional heat exchanger downstream of the hot heat exchanger before the heated rich solvent stream is delivered to the stripping column.

The various rich solvent streams entering the stripping column may be introduced at different places in the column, including above packed beds, between packed beds, or below packed beds, or at various locations within a trayed column as is well known in the art.

A first overhead heat exchanger may be provided on the heated rich solvent stream downstream of the hot heat exchanger, and a second overhead heat exchanger may be provided on the heated rich solvent stream downstream of the first overhead heat exchanger. The overhead stream may be compressed in a first overhead compressor forming a first compressed overhead stream. The first compressed overhead stream and a first heated rich solvent stream may be directed through the second overhead heat exchanger forming a first cooled overhead stream and a second heated rich solvent stream. The first cooled overhead stream may be compressed in a second overhead compressor forming a second compressed overhead stream. The second compressed overhead stream and the heated rich solvent stream may be directed through the first overhead heat exchanger forming a second cooled overhead stream and the first heated rich solvent stream. Contacting the compressed overhead stream with all or the portion of the warm rich bypass stream in the warm rich bypass overhead heat exchanger may comprise contacting the second cooled overhead stream with all or the portion of the warm rich bypass stream.

The second heated rich solvent may be heated in a steam heater or additional heat exchanger downstream of the second overhead heat exchanger before the second heated rich solvent stream is delivered to the stripping column.

The process may include a heat pump. The heat pump may comprise an evaporator, a compressor, a condenser, a pressure letdown device, and a working fluid stream. The condenser is a heat exchanger exchanging heat from a working fluid to a CO₂ containing solvent in which CO₂ is released, and the evaporator is a heat exchanger exchanging heat from a suitable low temperature heat source to the working fluid. The heat pump may have a cycle comprising heating the working fluid stream in the evaporator, compressing the heated working fluid stream in the compressor, cooling the compressed stream in the condenser, and reducing the pressure of the cooled stream in the pressure letdown device. A process stream having waste heat may be contacted with the working fluid stream in the evaporator forming a cooled process stream and the heated working fluid stream. The heated rich solvent stream may be contacted with the compressed working fluid stream in the condenser of the heat pump forming a second heated rich solvent stream and the cooled working fluid stream. A suitable vapor compression heat pump is described in U.S. Provisional Application Ser. No. 63/485,683, filed Feb. 17, 2023, entitled Solvent-Based CO₂ Capture Process Incorporating a Heat Pump, which is incorporated herein in its entirety.

In some embodiments, the low temperature heat source is a process stream from the CO₂ capture facility. In some embodiments, the low temperature heat source comprises a stream from a feed quench cooler, a stream from an absorber cooler, a stream from a lean solvent cooler, a stream from an overhead vapor condenser, a stream from a CO₂ compressor intercooler, a flue gas stream from a flue gas economizer, or combinations thereof from the CO₂ capture facility. The term flue gas economizer means that the economizer is placed on the flue gas stream that enters the absorber. The flue gas economizer is also referred to as a boiler economizer, a feedwater economizer, or an exhaust gas economizer by different entities.

In some embodiments, the heat pump can be a single stage heat pump or a two stage heat pump. In some embodiments, the single stage heat pump and the two stage heat pump can include an internal heat exchanger. In some embodiments where there is a single stage heat pump with an internal heat exchanger, the internal heat exchanger can be located in parallel with the evaporator. In some embodiments, the heat pump may comprise a two stage heat pump with a vapor/liquid separator in which the vapor is mixed with the first stage compressor effluent and directed to the second stage compressor suction. In some embodiments, the heat pump may comprise a two stage heat pump with a vapor/liquid separator in which a portion of the liquid is vaporized in a heat exchanger, combined with vapor from the first stage compressor effluent, and directed to the second stage compressor suction.

In some embodiments, the heat pump (both single stage and two stage) also includes an internal heat exchanger exchanging heat between the evaporator effluent and the condenser effluent. In some embodiments, the internal heat exchanger instead exchanges heat between the evaporator effluent and a stream located directly after a pressure letdown device. In these embodiments, the internal heat exchanger is placed in parallel with the evaporator, and the internal heat exchanger effluent and evaporator effluent are combined before the compressor suction. These embodiments may be needed in some cases to prevent two-phase flow in the compressor when the working fluid is classified as a thermodynamic “dry fluid,” and it typically applies to hydrocarbons such as butanes and pentanes. Two-phase flow in the compressor would destroy the compressor. An internal heat exchanger may not be needed for fluids classified as “isentropic” or “wet” because two-phase flow is not likely to be achieved in the compressor for these fluids.

In some embodiments, the evaporator comprises at least two heat exchangers in parallel. The working fluid is split upstream of the evaporator heat exchangers, heated in one or more of the evaporator heat exchangers, and combined downstream to form a single heated working fluid stream. One or more of the evaporator heat exchangers involves contacting a process stream having waste heat with the working fluid stream forming a cooled process stream and a first heated working fluid stream. A final evaporator heat exchanger involves contacting the working fluid stream with a suitable heating medium forming a first working fluid stream. Suitable heating media include steam, hot oil, an electric heating element, or a process stream with temperature greater than about 100° C. Working fluid flow through this final evaporator heat exchanger may be continuous or intermittent. The final evaporator heat exchanger provides a way to vaporize the working fluid using a heat source not coupled to the rest of the process. This can be beneficial during startup to vaporize the feed or during normal operations to provide additional heat to the heat pump system.

In some embodiments, the working fluid has a critical temperature 150° C. or greater and a normal boiling point 50° C. or less at 100 kPa. In some embodiments, the working fluid has a critical temperature 160° C. or greater and a normal boiling point 40° C. or less at 100 kPa.

In some embodiments, the working fluid comprises a chlorofluorocarbon, a hydrochlorofluorcarbon, a hydrofluorocarbon, a hydrofluoroolefin, a hydrochlorofluoroolefin, a hydrocarbon, an oxygenate, or combinations thereof. Suitable working fluids include, but are not limited to, trans-1-chloro-3,3,3-trifluoropropene, cis-1-chloro-3,3,3-trifluoropropene, trans-1-chloro-2,3,3,3-tetrafluoropropene, cis-1,1,1,4,4,4-hexafluoro-2-butene, n-butane, isobutane, n-pentane, isopentane, neopentane, cyclohexane, diethyl ether, methyl formate, ethylamine, a hydrochlorofluoroolefin having 3 carbon atoms, a hydrofluoroolefin having 4 carbon atoms, or combinations thereof.

Selection of an appropriate working fluid can be made by considering a number of factors, including, but not limited to, COP, toxicity, cost, and flammability. For example, isopentane is inexpensive and has low toxicity, but it has a lower COP than methyl formate. Methyl formate has a higher COP than isopentane, but it has toxicity concerns. C3 hydrochlorofluoroolefins and C4 hydrofluoroolefins are non-toxic, have low flammability, and have higher performance than hydrocarbons like isopentane, but they are more expensive than isopentane or methyl formate.

In some embodiments, the pressure letdown device is a valve. In other embodiments, the pressure letdown device is a pressure recovery turbine. The pressure recovery turbine adds capital cost, but reduces entropic losses when expanding a fluid compared to a valve. A pressure recovery turbine may be desirable for a single stage system, while letdown valves may be desirable for two stage systems.

In one embodiment, a process stream having waste heat (e.g., a temperature below the process pinch temperature, typically a temperature of 110° C. or less) is contacted with the working fluid stream in the evaporator. The working fluid is heated while the process stream is cooled. In one embodiment, the waste heat temperature is 70° C. or less.

An overhead heat exchanger may be provided on the heated rich solvent stream downstream of the hot heat exchanger. The overhead stream may be compressed in a first overhead compressor forming a first compressed overhead stream, and the first compressed overhead stream and the heated rich solvent stream may be directed through the overhead heat exchanger forming a first cooled overhead stream and a second heated rich solvent stream. The first cooled overhead stream may be compressed in a second overhead compressor forming a second compressed overhead stream. Contacting the compressed overhead stream with all or the portion of the warm rich bypass stream in the warm rich bypass overhead heat exchanger forming the heated warm rich bypass stream and the cooled compressed overhead stream may comprise contacting the second compressed overhead stream with all or the portion of the warm rich bypass stream in the warm rich bypass overhead heat exchanger forming the second heated warm rich bypass stream and a second cooled compressed overhead stream, and delivering all or a portion of the heated rich solvent stream to the stripping column may comprise delivering all or a portion of the second heated rich solvent stream to the stripping column.

An overhead heat exchanger may be provided on the heated rich solvent stream downstream of the hot heat exchanger. The cooled overhead stream may be compressed in a second overhead compressor forming a second compressed overhead stream. The second compressed overhead stream and the heated rich solvent stream may be directing through the overhead heat exchanger forming a second cooled overhead stream and a second heated rich solvent stream. Delivering all or a portion of the heated rich solvent stream to the stripping column may comprise delivering all or a portion of the second heated rich solvent stream to the stripping column.

A second warm rich bypass overhead heat exchanger may be provided on the heated warm rich bypass stream from the warm rich bypass heat exchanger. The overhead stream may be compressed in a first overhead compressor forming a first compressed overhead stream, with the first compressed overhead stream and the heated warm rich bypass solvent stream being directing through the second warm rich bypass overhead heat exchanger forming a first cooled overhead stream and a second heated warm rich bypass solvent stream. The first cooled overhead stream in the second overhead compressor may be compressed forming a second compressed overhead stream. Contacting the compressed overhead stream with all or the portion of the warm rich bypass stream in the warm rich bypass overhead heat exchanger forming the heated warm rich bypass stream and the cooled compressed overhead stream may comprise contacting the second compressed overhead stream with all or the portion of the warm rich bypass stream in the warm rich bypass overhead heat exchanger forming the second heated warm rich bypass stream and the second cooled compressed overhead stream. Directing the heated warm rich bypass stream to the stripping column may comprise directing the second heated warm rich bypass stream to the stripping column.

The heated warm rich bypass stream and the heated rich solvent stream may be combined, and delivering all or a portion of the heated rich solvent stream to the stripping column and directing the heated warm rich bypass stream to the stripping column may comprise directing the combined stream to the stripping column.

The cooled compressed overhead stream may be compressed in a second overhead compressor forming a second compressed overhead stream. The second compressed overhead stream may be contacted with the heated rich solvent stream in an additional heat exchanger on the heated rich solvent stream, the additional heat exchanger being downstream of the hot heat exchanger forming a second heated rich solvent stream and a second cooled compressed overhead stream. Delivering all or a portion of the heated rich solvent stream to the stripping column may comprise delivering all or a portion of the second heated rich solvent stream to the stripping column.

Another aspect of the invention is a process for CO₂ recovery from flue gas. In one embodiment, the process comprises introducing a flue gas stream and a cooled lean solvent stream into an absorber column forming a purified flue gas stream and a rich solvent stream comprising CO₂. The rich solvent stream is directed through a cold heat exchanger followed by a hot heat exchanger, and a lean solvent stream is directed from the stripping column through the hot heat exchanger followed by the cold heat exchanger forming a first heated rich solvent stream and the cooled lean solvent stream. A heated rich solvent stream is delivered to the stripping column and forms an overhead stream comprising CO₂ and the lean solvent stream. The overhead stream is compressed forming a first compressed overhead stream. A warm rich bypass stream is separated from the rich solvent stream downstream of the cold heat exchanger and upstream of the hot heat exchanger, and the warm rich bypass stream is directed to the stripping column. The first heated rich solvent stream and the first compressed overhead stream are directed through an overhead heat exchanger forming a first cooled overhead stream and a second heated rich solvent stream, the first overhead heat exchanger being downstream of the hot heat exchanger on the first heated rich solvent stream. Delivering the heated rich solvent stream to the stripping column comprises delivering the second heated rich solvent stream to the stripping column.

A cold rich bypass stream may be separated from the rich solvent stream upstream of the cold heat exchanger and directing the cold rich bypass stream and the first cooled overhead stream to a CO₂ heat exchanger forming a heated cold rich bypass stream and a second cooled overhead stream. The heated cold rich bypass stream may be directed to the stripping column.

The warm rich bypass stream and the heated cold rich bypass stream may be combined, and the combined stream may be directed to the stripping column.

The second heated rich solvent may be heated in a steam heater or an additional heat exchanger downstream of the first overhead heat exchanger before the second heated rich solvent stream is delivered to the stripping column.

A heat pump may be provided. The heat pump may comprise an evaporator, a compressor, a condenser, a pressure letdown device, and a working fluid stream, and have a cycle comprising heating the working fluid stream in the evaporator, compressing the heated working fluid stream in the compressor, cooling the compressed stream in the condenser, and reducing the pressure of the cooled stream in the pressure letdown device. A process stream having waste heat may be contacted with the working fluid stream in the evaporator forming a cooled process stream and the heated working fluid stream, and the second heated rich solvent stream may be contacted with the compressed working fluid stream in the condenser of the heat pump forming a third heated rich solvent stream and the cooled working fluid stream.

Another aspect of the invention is a process for CO₂ recovery from flue gas. In one embodiment, the process comprises introducing a flue gas stream and a cooled lean solvent stream into an absorber column forming a purified flue gas stream and a rich solvent stream comprising CO₂. The rich solvent stream is directed through a cold heat exchanger followed by a hot heat exchanger and directing a lean solvent stream from a stripping column through the hot heat exchanger followed by the cold heat exchanger forming a first heated rich solvent stream and the cooled lean solvent stream. A heated rich solvent stream is delivered to the stripping column, and an overhead stream comprising CO₂ and the lean solvent stream are formed. The overhead stream is compressed forming a first compressed overhead stream. A warm rich bypass stream is separated from the rich solvent stream downstream of the cold heat exchanger and upstream of the hot heat exchanger, and the warm rich bypass stream is directed to the stripping column. The first heated rich solvent stream and a second compressed overhead stream are directed through a second overhead heat exchanger forming a second cooled overhead stream and a second heated rich solvent stream. The second overhead heat exchanger is downstream of the hot heat exchanger and upstream of a first overhead heat exchanger on the heated rich solvent stream. The second heated rich solvent stream and the first compressed overhead stream are directed through the first overhead heat exchanger forming a first cooled overhead stream and a third heated rich solvent stream. The first cooled overhead stream is compressed forming the second compressed overhead stream. Delivering the heated rich solvent stream to the stripping column comprises delivering the third heated rich solvent stream to the stripping column.

A cold rich bypass stream may be separated from the rich solvent stream upstream of the cold heat exchanger. The cold rich bypass stream and the second cooled compressed overhead stream may be directed to a CO₂ heat exchanger forming a heated cold rich bypass stream and a third cooled overhead stream, and the heated cold rich bypass stream may be directed to the stripping column.

The warm rich bypass stream and the heated cold rich bypass stream may be combined, and directed to the stripping column.

The third heated rich solvent may be heated in a steam heater or an additional heat exchanger downstream of the first overhead heat exchanger before the second heated rich solvent stream is delivered to the stripping column.

The process may include a heat pump, as described above.

Another aspect of the invention comprises an apparatus for recovering heat from an overhead stream of a stripping column in a CO₂ capture process. In one embodiment, the apparatus comprises an absorber column having a flue gas inlet, a flue gas outlet, a lean solvent inlet, and a rich solvent outlet. There is a stripping column having a first rich solvent inlet, a second rich solvent inlet, an overhead outlet, and a lean solvent outlet. The apparatus includes a cold heat exchanger having a rich solvent inlet, a rich solvent outlet, a lean solvent inlet, and a lean solvent outlet. The rich solvent inlet of the cold heat exchanger is in downstream fluid communication with the rich solvent outlet of the absorber. There is a hot heat exchanger having a rich solvent inlet, a rich solvent outlet, a lean solvent inlet, and a lean solvent outlet. The rich solvent inlet of the hot heat exchanger is in downstream fluid communication with the rich solvent outlet of the cold heat exchanger, the rich solvent inlet of the stripping column is in downstream fluid communication with the rich solvent outlet of the hot heat exchanger, the lean solvent inlet of the hot heat exchanger is in downstream fluid communication with the lean solvent outlet of the stripping column, the lean solvent inlet of the cold heat exchanger is in downstream fluid communication with the lean solvent outlet of the hot heat exchanger, and the lean solvent inlet of the absorber is in downstream fluid communication with the lean solvent outlet of the cold heat exchanger. There is a compressor having an inlet and an outlet, and the compressor inlet is in fluid communication with the overhead outlet of the stripping column. There is an overhead heat exchanger having an overhead inlet, an overhead outlet, a rich solvent inlet, and a rich solvent outlet. The overhead inlet of the overhead heat exchanger is in downstream fluid communication with the compressor outlet, the rich solvent inlet of the overhead heat exchanger is in downstream fluid communication with the rich solvent outlet of the cold heat exchanger, and the second rich solvent inlet of the stripping column is in downstream fluid communication with the rich solvent outlet of the overhead heat exchanger.

The overhead compressor may be combined with a CO₂ product compressor and shares a common driver with the CO₂ product compressor.

The overhead compressor may comprise an integrally geared centrifugal compressor.

The overhead compressor may comprise a double-flow inlet compressor.

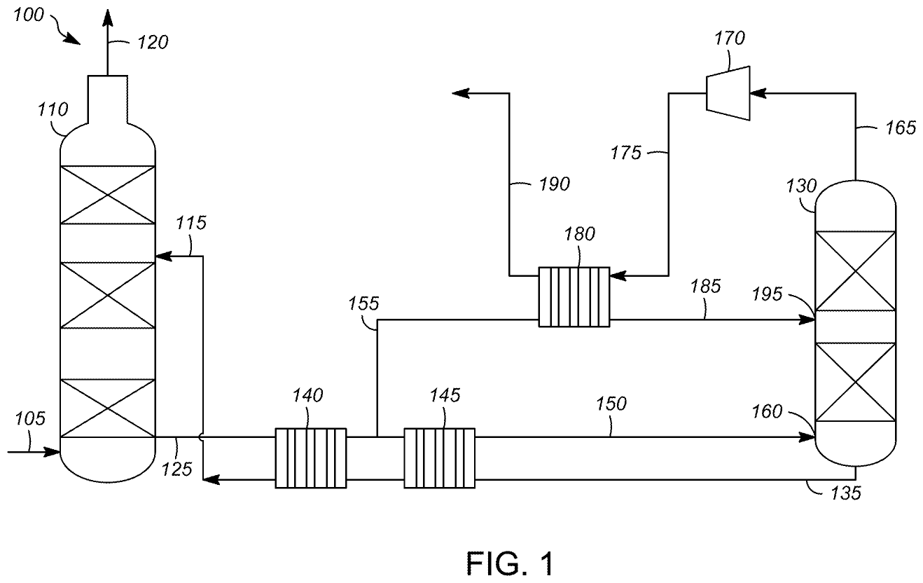

FIG. 1 illustrates one embodiment of a CO₂ capture process 100 using a flash stripping column.

The flue gas stream 105, which contains CO₂, is sent to the absorber column 110 where it contacts the lean solvent stream 115. The CO₂ is transferred from the flue gas to the lean solvent, forming a purified flue gas stream 120 and a rich solvent stream 125.

The rich solvent stream 125 exchanges heat with the lean solvent stream 135 in the cold heat exchanger 140 and hot heat exchanger 145 forming heated rich solvent stream 150 and cooled lean solvent stream 115.

A warm rich bypass stream 155 is taken from the partially heated rich solvent stream between the cold heat exchanger 140 and the hot heat exchanger 145.

The heated rich solvent stream 150 is introduced into the stripping column 130 at a first point 160 and flashed to separate the CO₂ from the solvent, forming the overhead stream 165 comprising the CO₂ and the lean solvent stream 135.

The overhead stream 165 is sent to a compressor 170 forming a compressed overhead stream 175. The compressed overhead stream 175 is contacted with the warm rich bypass stream 155 in warm rich bypass overhead heat exchanger 180 forming heated warm rich bypass stream 185 and cooled compressed overhead stream 190. The heated warm rich bypass stream 185 is introduced into the stripping column 130 at a second point 195.

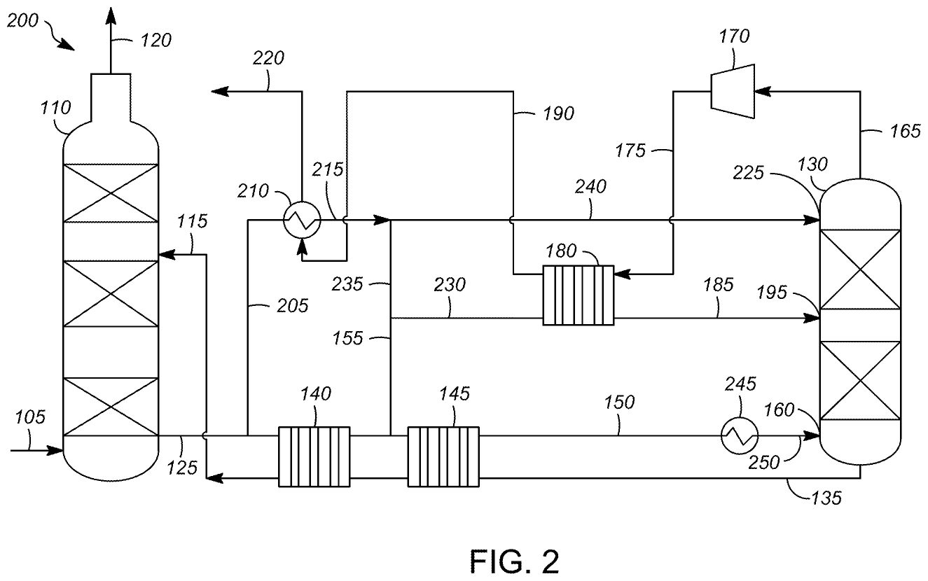

In the process of FIG. 2, a cold rich bypass stream 205 is removed from the rich solvent stream 125 upstream of the cold heat exchanger 140. The cold rich bypass stream 205 is heated with a heater or heat exchanger 210 with the cooled compressed overhead stream 190 forming a heated cold rich bypass stream 215 and a second cooled overhead stream 220. The heated cold rich bypass stream 215 is sent to the stripping column 130 at a third point 225. Water can be condensed from the second cooled overhead stream 220 (not shown).

The warm rich bypass stream 155 can be divided into a first portion 230 and a second portion 235. The first portion 230 can be contacted with the compressed overhead stream 175 in the warm rich bypass overhead heat exchanger 180. The second portion 235 can be combined with the heated cold rich bypass stream 215 forming a combined stream 240 which is sent to the stripping column 130 at the third point 225.

The heated rich solvent stream 150 can be further heated in a steam heater or heat exchanger 245 and the second heated rich solvent stream 250 can be sent to the stripping column 130.

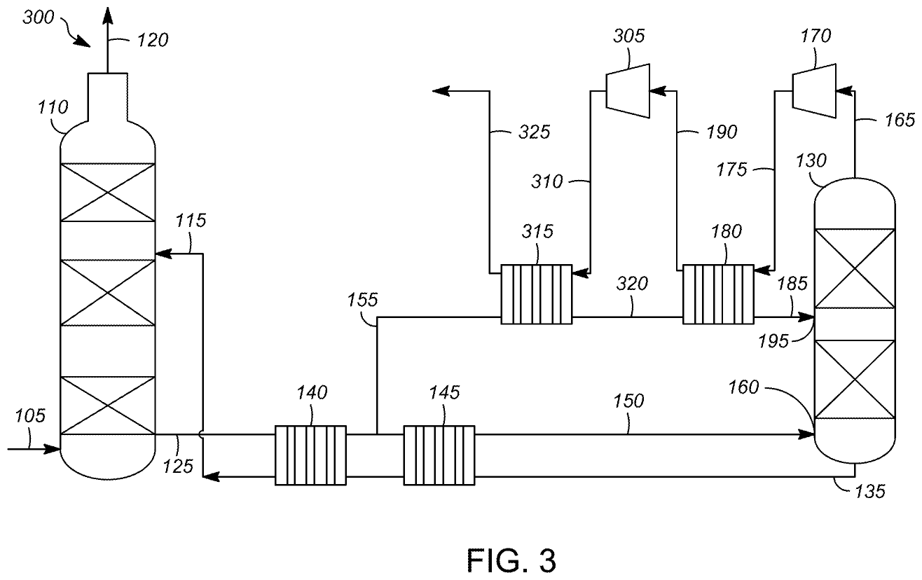

In the process 300 of FIG. 3, there is a second warm rich bypass overhead heat exchanger 315 upstream of the warm rich bypass overhead heat exchanger 180. The overhead stream 165 is compressed in compressor 170, and the compressed overhead stream 175 is sent to the warm rich bypass overhead heat exchanger 180 forming the heated warm rich bypass stream 185 and the cooled compressed overhead stream 190.

The cooled compressed overhead stream 190 is sent to a second compressor 305 forming a second compressed overhead stream 310. The second compressed overhead stream 310 is contacted with the warm rich bypass stream 155 in the second warm rich bypass overhead heat exchanger 315 forming a second heated warm rich bypass stream 320 and a second cooled compressed overhead stream 325. The second heated warm rich bypass stream 320 is sent to the warm rich bypass overhead heat exchanger 180 and contacted with the compressed overhead stream 175.

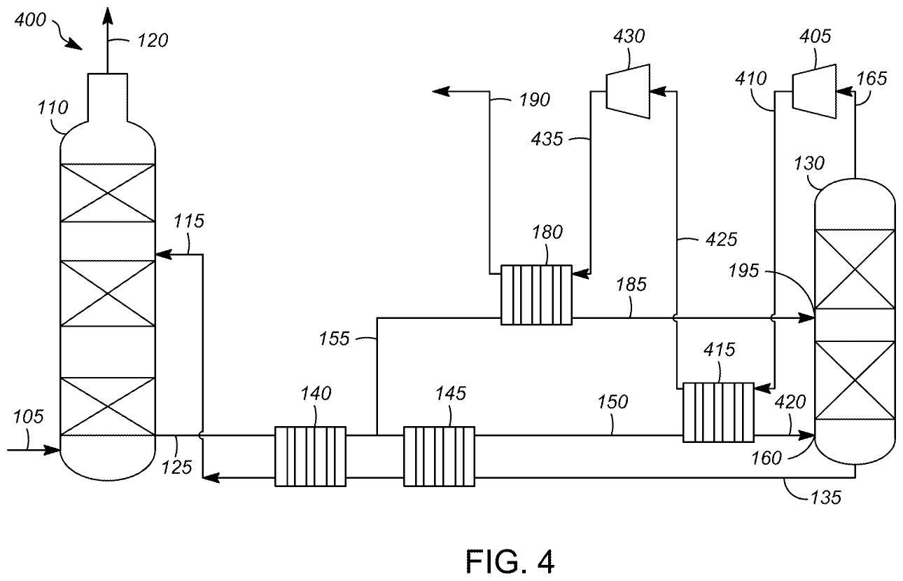

FIG. 4 illustrates another process 400. In this process, the overhead stream 165 is compressed in a first overhead compressor 405. The first compressed overhead stream 410 is contacted with the heated rich solvent stream 150 in an additional heat exchanger 415 forming a second heated rich solvent stream 420 and a first cooled compressed overhead stream 425. The additional heat exchanger 415 is downstream of the hot heat exchanger 145.

The first cooled compressed overhead stream 425 is sent to a second overhead compressor 430, and the second compressed overhead stream 435 is sent to the warm rich bypass overhead heat exchanger 180 forming heated warm rich bypass stream 185 and cooled compressed overhead stream 190.

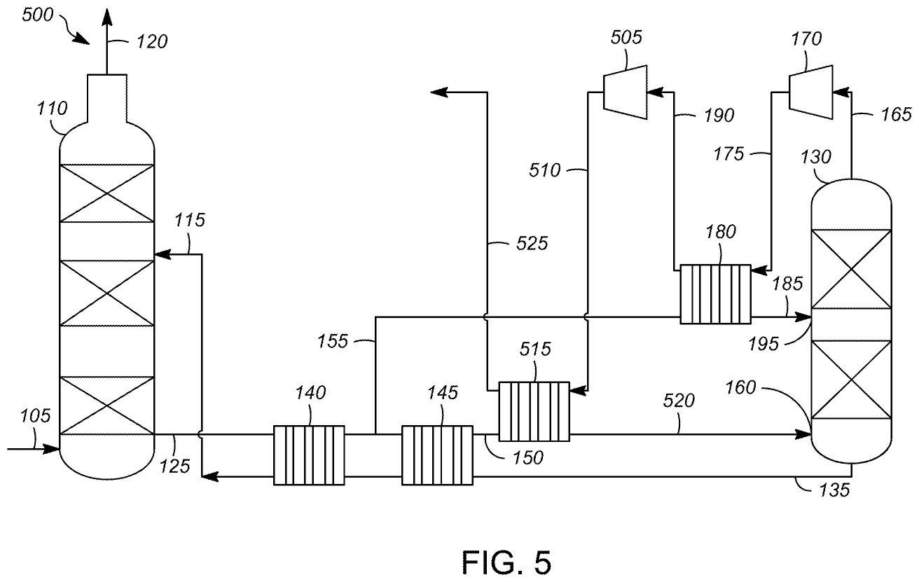

In the process 500 shown in FIG. 5, the cooled compressed overhead stream 190 is compressed in a second overhead compressor 505 forming a second compressed overhead stream 510. The second compressed overhead stream 510 is contacted with the heated rich solvent stream 150 in an additional heat exchanger 515 forming second heated rich solvent stream 520 and second cooled compressed overhead stream 525. The additional heat exchanger 515 is on the heated rich solvent stream downstream of the hot heat exchanger 145. The second heated rich solvent stream 520 is sent to the stripping column 130.

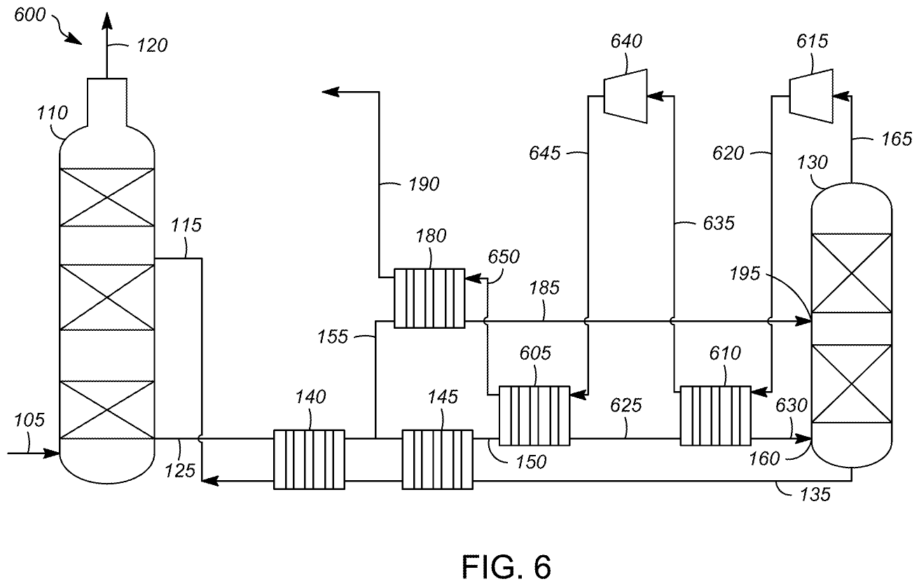

In the process 600 of FIG. 6, there are a first overhead heat exchanger 605 and a second overhead heat exchanger 610 on the heated rich solvent stream 150. The first overhead heat exchanger 605 is downstream of the hot heat exchanger 145, and the second overhead heat exchanger 610 is downstream of the first overhead heat exchanger 605.

The overhead stream 165 is sent to a first overhead compressor 615 forming first compressed overhead stream 620. The first compressed overhead stream 620 is contacted with a second heated rich solvent stream 625 in the second overhead heat exchanger 610 forming a third heated rich solvent stream 630 and a cooled compressed overhead stream 635. The third heated rich solvent stream 630 is sent to the stripping column 130.

The cooled compressed overhead stream 635 is sent to a second overhead compressor 640 forming a second compressed overhead stream 645. The second compressed overhead stream 645 is contacted with the heated rich solvent stream 150 forming second heated rich solvent stream 625 and a second cooled compressed overhead stream 650.

The second cooled compressed overhead stream 650 is contacted with the warm rich bypass stream 155 in the warm rich bypass overhead heat exchanger 180 forming the heated warm rich bypass stream 185 and the cooled compressed overhead stream 190.

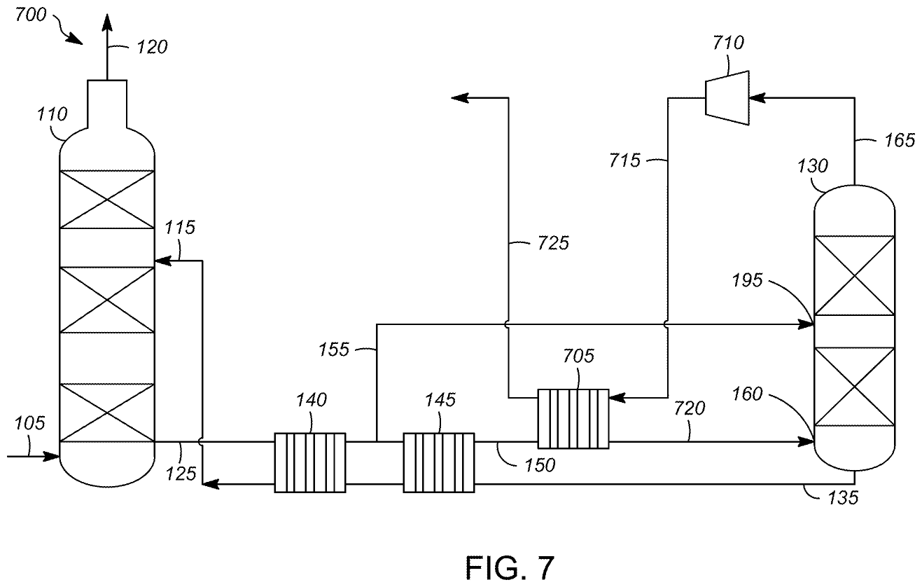

The process 700 shown in FIG. 7, there is a first additional overhead heat exchanger 705 on the heated rich solvent stream 150 downstream from the hot heat exchanger 145. The overhead stream 165 is sent to a first overhead compressor 710 forming first overhead compressed stream 715.

The first overhead compressed stream 715 is contacted with the heated rich solvent stream 150 in the first additional overhead heat exchanger 705 forming second heated rich solvent stream 720 and cooled compressed overhead stream 725. The second heated rich solvent stream 720 is sent to the stripping column 130.

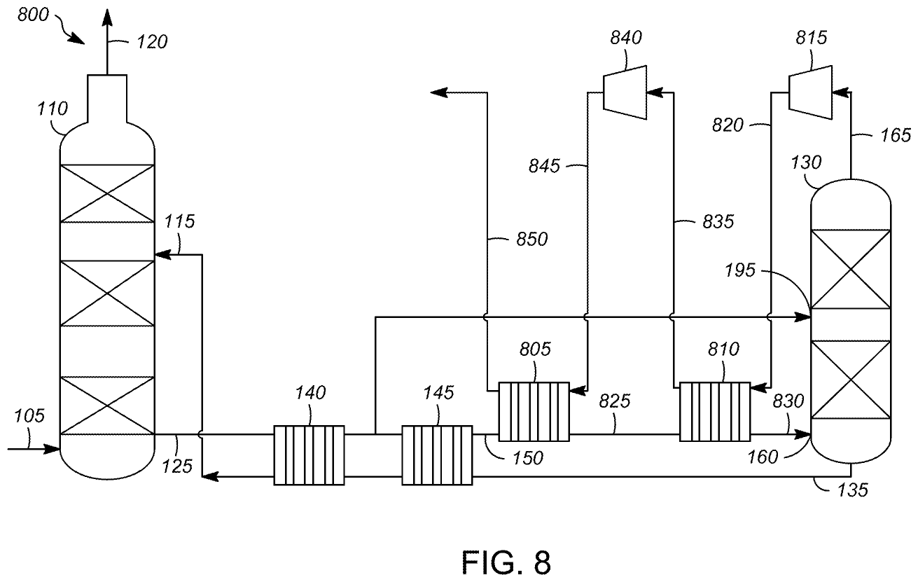

In the process 800 illustrated in FIG. 8, there is a first overhead heat exchanger 805 on the heated rich solvent stream 150 downstream of the hot heat exchanger 145 and a second overhead heat exchanger 810 downstream of the first overhead heat exchanger 805.

The overhead stream 165 is compressed in a first overhead compressor 815 forming a first compressed overhead stream 820. The first compressed overhead stream 820 is sent to the second overhead heat exchanger 810 and contacted with a second heated rich solvent stream 825 forming third heated rich solvent stream 830 and first cooled overhead stream 835. The third heated rich solvent stream 830 is sent to the stripping column 130.

The first cooled overhead stream 835 is sent to a second overhead compressor 840 forming a second compressed overhead stream 845. The second compressed overhead stream 845 is contacted with the heated rich solvent stream 150 in the first overhead heat exchanger 805 forming the second heated rich solvent stream 825 and the second cooled overhead stream 850.

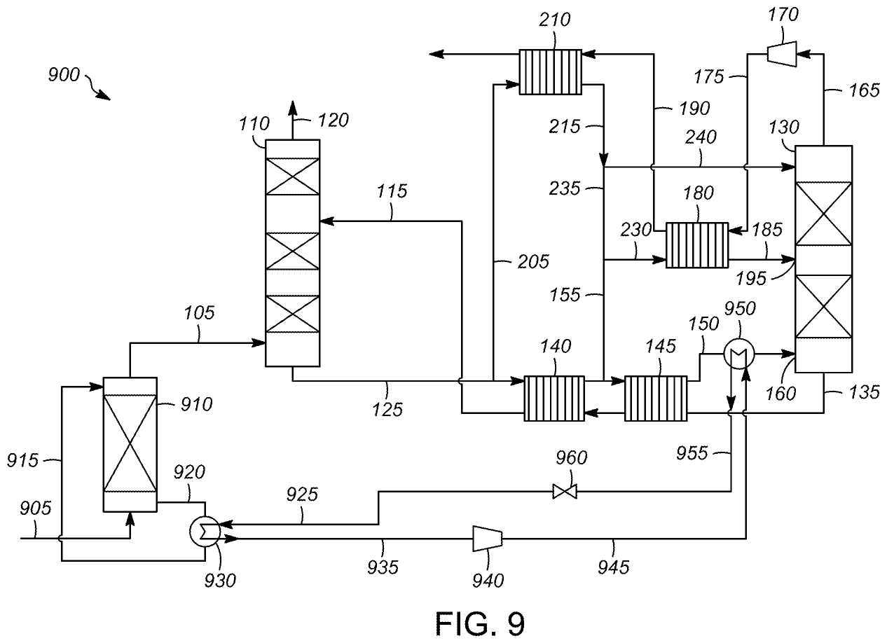

As shown in FIG. 9, the process 900 can include a heat pump.

The flue gas stream 905, which contains CO₂, is sent to a quench column 910 where it is contacted with a quench stream 915 forming a cooled flue gas stream 105 and a heated quench stream 920. The cooled flue gas stream 105 is sent to the absorber column 110 where it contacts the lean solvent stream 115.

The heated quench stream 920 contacts the working fluid stream 925 in the evaporator 930 forming a heated working fluid stream 935 and the quench stream 915. The heated working fluid stream 935 is compressed in heat pump compressor 940 forming compressed working fluid stream 945. The compressed working fluid stream 945 is contacted with the heated rich solvent stream 150 in the condenser 950 which further heats the heated rich solvent stream 150 and cools the compressed working fluid stream 945. The cooled compressed working fluid stream 955 is expanded in the pressure let down device 960 forming the working fluid stream 925.

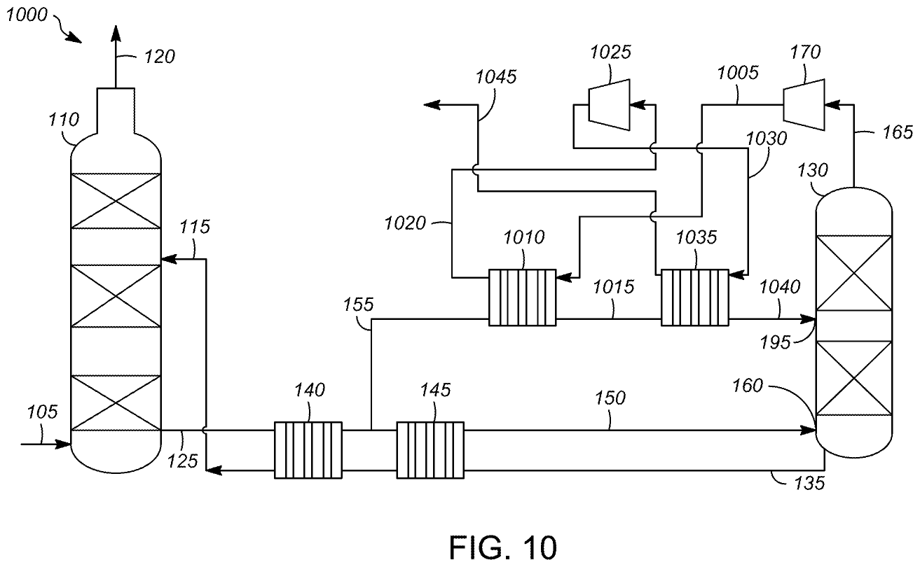

The process 1000 of FIG. 10 is similar to the process 300 shown in FIG. 3, except that flow of the overhead stream 165 is different. The second warm rich bypass overhead heat exchanger 1035 is downstream of the warm rich bypass overhead heat exchanger 1010. The overhead stream 165 is compressed in compressor 170. The compressed overhead stream 1005 is heat exchanged with warm rich bypass stream 155 in the warm rich bypass overhead heat exchanger 1010 forming the heated warm rich bypass stream 1015 and the cooled compressed overhead stream 1020.

The cooled compressed overhead stream 1020 is sent to a second compressor 1025 forming a second compressed overhead stream 1030. The second compressed overhead stream 1030 is contacted with the heated warm rich bypass stream 1015 in the second warm rich bypass overhead heat exchanger 1035 forming a second heated warm rich bypass stream 1040 and a second cooled compressed overhead stream 1045. The second heated warm rich bypass stream 1040 is sent to the stripping column 130.

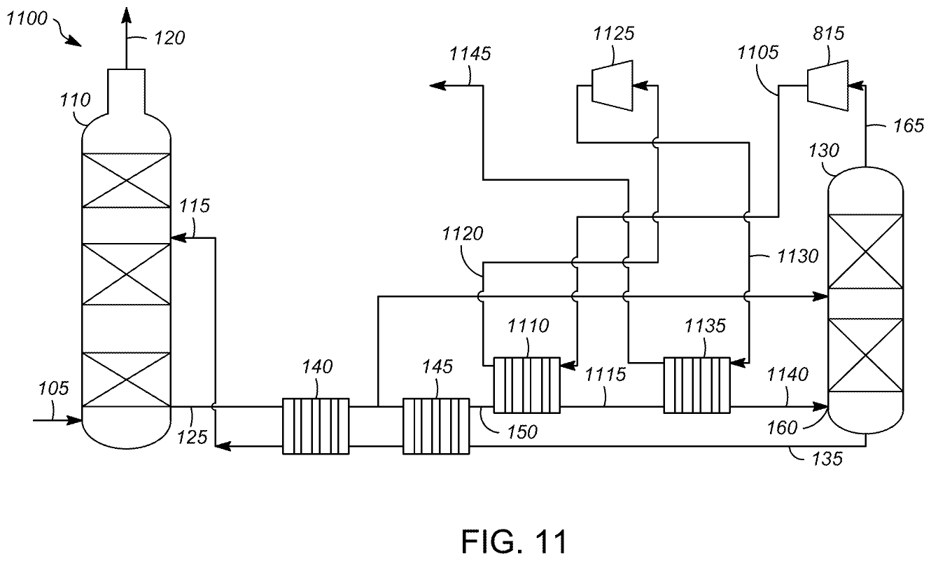

The process in FIG. 11 is similar to the process 800 shown in FIG. 8, except that the flow of the overhead stream 165 is different. The overhead stream 165 is compressed in a first overhead compressor 815 forming a first compressed overhead stream 1105. The first compressed overhead stream 1105 is sent to the first overhead heat exchanger 1110 and contacted with the heated rich solvent stream 150 forming a second heated rich solvent stream 1115 and first cooled overhead stream 1120.

The first cooled overhead stream 1120 is sent to a second overhead compressor 1125 forming a second compressed overhead stream 1130. The second compressed overhead stream 1130 is contacted with the second heated rich solvent stream 1115 in the second overhead heat exchanger 1135 forming a third heated rich solvent stream 1140 and the second cooled overhead stream 1145. The third heated rich solvent stream 1140 is sent to the stripping column 130.

Any of the processes of FIGS. 1-11 can include the cold rich solvent bypass stream as shown in FIGS. 2 and 9.

Any of the processes of FIGS. 1-11 can include the heat pump as shown in FIG. 9.

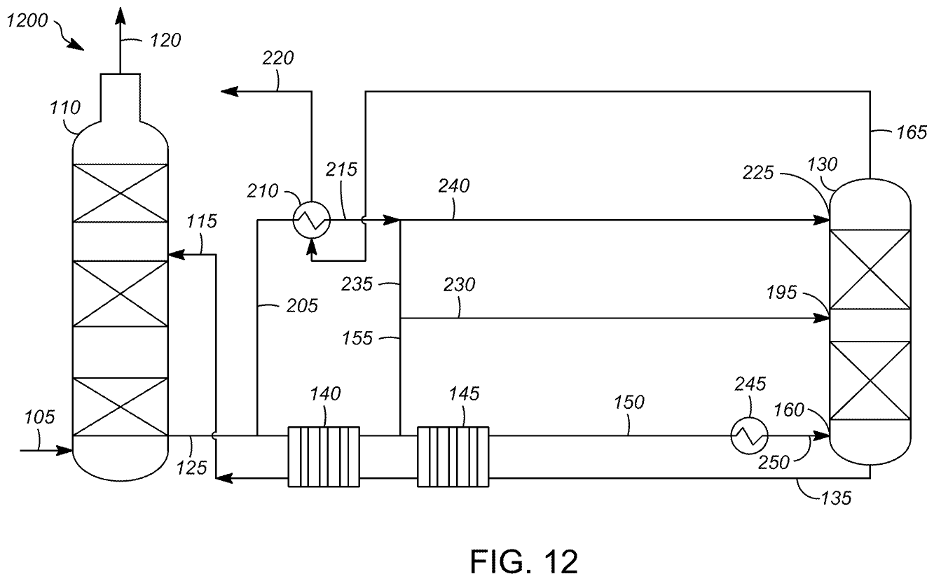

FIG. 12 illustrates a CO₂ capture process 1200 using a flash stripping column without the overhead compressor 170 and heat exchanger 180 for comparison.

The flue gas stream 105, which contains CO₂, is sent to the absorber column 110 where it contacts the lean solvent stream 115. The CO₂ is transferred from the flue gas to the lean solvent, forming a purified flue gas stream 120 and a rich solvent stream 125. The rich solvent stream 125 is sent to the stripping column 130.

A cold rich solvent bypass stream 205 of the rich solvent stream 125 is sent to a heat exchanger 210 to exchange heat with the overhead stream 165 from the stripping column 130 forming a heated first portion 215 and a cooled overhead stream 220.

The remainder of the rich solvent stream 125 exchanges heat with the lean solvent stream 135 in the cold heat exchanger 140 partially heating the rich solvent stream 125 and cooling the lean solvent stream 135.

A warm rich solvent stream 155 is taken from the rich solvent stream 125 after the cold heat exchanger 140. The warm rich solvent stream 155 is divided into a first portion 230 and a second portion 235. The first portion 230 is sent to the stripping column 130. The second portion 235 is combined with the heated first portion 215, and the combined stream 240 is sent to the stripping column 130.

The rest of the rich solvent stream is sent to the hot heat exchanger 145 further heating the rich solvent stream 125 forming heated stream 150.

The heated rich solvent stream 150 is sent to a steam heater 225 for additional heating forming a second heated rich solvent stream 250 before being introduced into the stripping column 130 where the CO₂ is stripped from the second heated rich solvent stream 250, forming the overhead stream 165 comprising the CO₂ and the lean solvent stream 135.

After the lean solvent stream 135 is passed through the hot heat exchanger 145 and the cold heat exchanger 140, the cooled lean solvent stream 115 is returned to the absorber column 110.

### EXAMPLES

### Comparative Example 1

The CO₂ capture process of FIG. 12 was simulated using Aspen Plus® process modeling software using rate-based heat and mass transfer models for the absorber and stripping column and proprietary thermodynamic and kinetic models for an amine solvent for CO₂ absorption and stripping. GERG-2008 equation of state was used to model CO₂ compression. Table 1 provides simulated stream properties for the stripping column overhead acid gas stream 165 before and after heat exchange with a cold rich solvent bypass stream in heat exchanger 210. 9.62 MWₜₕ heat is recovered from the stripping column overhead acid gas stream in heat exchanger 210 resulting in a base duty in steam heater 245. The remaining water in cooled overhead stream 220 is condensed and removed at 40° C. before compressing the cooled overhead acid gas stream 220 to a pipeline pressure of 150 bar(a). This additional compression requires an additional 9.16 MWₑ electricity.

TABLE 1
Acid gas stream properties, comparative example 1.

| | | |
|---|---|---|
| Stream | 165 | 220 |
| Temperature (° C.) | 121 | 101 |
| Pressure (kPa(a)) | 549 | 528 |
| Enthalpy (MW) | −409.4 | −419.0 |
| Mass Flow (kg/h) | 153,188 | 153,188 |
| Mol Frac. H₂O | 0.341 | 0.341 |
| Mol Frac. CO₂ | 0.659 | 0.659 |

### Example 1

The CO₂ capture process of FIG. 2 was simulated using Aspen Plus® process modeling software using rate-based heat and mass transfer models for the absorber and stripping column and proprietary thermodynamic and kinetic models for an amine solvent for CO₂ absorption and stripping. GERG-2008 equation of state was used to model CO₂ compression. The process was simulated using the same basis as in comparative example 1 resulting in the same rich solvent stream 125. Table 2 provides simulated stream properties for the stripping column overhead acid gas stream before compression (stream 165), after compression in overhead exchanger 170 (stream 175), after heat exchange in exchanger 180 (stream 190), and after heat exchange in exchanger 210 (stream 220). Compressing the acid gas stream 165 in overhead compressor 170 requires 3.44 MWₑ electricity. 8.72 MWₜₕ heat is recovered from the acid gas stream in exchanger 180, and 9.97 MWₜₕ heat is recovered from the acid gas stream in exchanger 210. The duty in steam heater 245 is reduced by 8.69 MWₜₕ from the base value in comparative example 1 due to the additional heat recovery in the acid gas stream versus comparative example 1. The remaining water in stream 220 is condensed and knocked out at 40° C. before compressing the acid gas stream to a pipeline pressure of 150 bar(a) requiring an additional 7.22 MWₑ electricity.

The total compression electricity to compress to 150 bar(a) pipeline pressure is 10.66 MWₑ which is 1.50 MWₑ higher than comparative example 1. The overhead compressor process of example 1 reduces steam heater duty by 8.69 MWₜₕ versus comparative example 1 while requiring an additional 1.50 MWₑ electricity resulting in a coefficient of performance of 5.8 MWₜₕ thermal duty reduction per additional 1 MWₑ electricity required versus comparative example 1.

TABLE 2
Acid gas stream properties, example 1.

| | | | | |
|---|---|---|---|---|
| Stream | 165 | 175 | 190 | 220 |
| Temperature (° C.) | 121 | 194 | 128 | 94 |
| Pressure (kPa(a)) | 548 | 1069 | 1034 | 1013 |
| Enthalpy (MW) | −410.7 | −407.2 | −416 | −425.9 |
| Mass Flow (kg/h) | 153,629 | 153,629 | 153,629 | 153,629 |
| Mol Frac. H₂O | 0.342 | 0.342 | 0.342 | 0.342 |
| Mol Frac. CO₂ | 0.658 | 0.658 | 0.658 | 0.658 |

### SPECIFIC EMBODIMENTS

While the following is described in conjunction with specific embodiments, it will be understood that this description is intended to illustrate and not limit the scope of the preceding description and the appended claims.

A first embodiment of the invention is a process for CO₂ recovery from flue gas comprising introducing a flue gas stream and a cooled lean solvent stream into an absorber column forming a purified flue gas stream and a rich solvent stream comprising CO₂; directing the rich solvent stream through at least a cold heat exchanger followed by a hot heat exchanger and directing a lean solvent stream from a stripping column through the hot heat exchanger followed by the cold heat exchanger forming a heated rich solvent stream and the cooled lean solvent stream; delivering all or a portion of the heated rich solvent stream to the stripping column and forming the lean solvent stream and an overhead stream; compressing the overhead stream forming a compressed overhead stream; separating a warm rich bypass stream from the rich solvent stream downstream of the cold heat exchanger and upstream of the hot heat exchanger; contacting the compressed overhead stream with all or a portion of the warm rich bypass stream in a warm rich bypass overhead heat exchanger forming a heated warm rich bypass stream and a cooled compressed overhead stream; and directing the heated warm rich bypass stream to the stripping column. An embodiment of the invention is one, any or all of prior embodiments in this paragraph up through the first embodiment in this paragraph further comprising dividing the warm rich bypass stream into a first portion and a second portion; and directing the second portion of the warm rich bypass stream to the stripping column. An embodiment of the invention is one, any or all of prior embodiments in this paragraph up through the first embodiment in this paragraph further comprising separating a cold rich bypass stream from the rich solvent stream upstream of the cold heat exchanger and directing the cold rich bypass stream and the cooled compressed overhead stream through a CO₂ heat exchanger forming a heated cold rich bypass stream and a second cooled overhead stream; and directing the heated cold rich bypass stream to a third point on the stripping column. An embodiment of the invention is one, any or all of prior embodiments in this paragraph up through the first embodiment in this paragraph further comprising dividing the warm rich bypass stream into a first portion and a second portion; combining the second portion of the warm rich bypass stream and the heated cold rich bypass stream forming a combined stream; and directing the combined stream to the stripping column. An embodiment of the invention is one, any or all of prior embodiments in this paragraph up through the first embodiment in this paragraph further comprising heating the heated rich solvent in a steam heater or an additional heat exchanger downstream of the hot heat exchanger before the heated rich solvent stream is delivered to the stripping column. An embodiment of the invention is one, any or all of prior embodiments in this paragraph up through the first embodiment in this paragraph further comprising providing a heat pump comprising an evaporator, a compressor, a condenser, a pressure letdown device, and a working fluid stream, the heat pump having a cycle comprising heating the working fluid stream in the evaporator, compressing the heated working fluid stream in the compressor, cooling the compressed stream in the condenser, and reducing the pressure of the cooled stream in the pressure letdown device; contacting a process stream having waste heat with the working fluid stream in the evaporator forming a cooled process stream and the heated working fluid stream; and contacting the heated rich solvent stream with the compressed working fluid stream in the condenser of the heat pump forming a second heated rich solvent stream and the cooled working fluid stream. An embodiment of the invention is one, any or all of prior embodiments in this paragraph up through the first embodiment in this paragraph further comprising providing an overhead heat exchanger on the heated rich solvent stream downstream of the hot heat exchanger; compressing the overhead stream in a first overhead compressor forming a first compressed overhead stream; directing the first compressed overhead stream and the heated rich solvent stream through the overhead heat exchanger forming a first cooled overhead stream and a second heated rich solvent stream; and compressing the first cooled overhead stream in a second overhead compressor forming a second compressed overhead stream; wherein contacting the compressed overhead stream with all or the portion of the warm rich bypass stream in the warm rich bypass overhead heat exchanger forming the heated warm rich bypass stream and the cooled compressed overhead stream comprises contacting the second compressed overhead stream with all or the portion of the warm rich bypass stream in the warm rich bypass overhead heat exchanger forming the second heated warm rich bypass stream and a second cooled compressed overhead stream; and wherein delivering all or a portion of the heated rich solvent stream to the stripping column comprises delivering all or a portion of the second heated rich solvent stream to the stripping column. An embodiment of the invention is one, any or all of prior embodiments in this paragraph up through the first embodiment in this paragraph further comprising providing a second warm rich bypass overhead heat exchanger on the heated warm rich bypass stream downstream from the warm rich bypass heat exchanger; compressing the cooled compressed overhead stream in a second overhead compressor forming a second compressed overhead stream; directing the second compressed overhead stream and the heated warm rich bypass solvent stream through the second warm rich bypass overhead heat exchanger forming a first cooled compressed overhead stream and a second heated warm rich bypass solvent stream; and wherein directing the heated warm rich bypass stream to the stripping column comprises directing the second heated warm rich bypass stream to the stripping column. An embodiment of the invention is one, any or all of prior embodiments in this paragraph up through the first embodiment in this paragraph further comprising combining the heated warm rich bypass stream and the heated rich solvent stream forming a combined stream; and wherein delivering all or a portion of the heated rich solvent stream to the stripping column and directing the heated warm rich bypass stream to the stripping column comprises directing the combined stream to the stripping column. An embodiment of the invention is one, any or all of prior embodiments in this paragraph up through the first embodiment in this paragraph further comprising compressing the cooled compressed overhead stream in a second overhead compressor forming a second compressed overhead stream; contacting the second compressed overhead stream with the heated rich solvent stream in an additional heat exchanger on the heated rich solvent stream, the additional heat exchanger being downstream of the hot heat exchanger forming a second heated rich solvent stream and a second cooled compressed overhead stream; and wherein delivering all or a portion of the heated rich solvent stream to the stripping column comprises delivering all or a portion of the second heated rich solvent stream to the stripping column. An embodiment of the invention is one, any or all of prior embodiments in this paragraph up through the first embodiment in this paragraph further comprising providing a first overhead heat exchanger on the heated rich solvent stream downstream of the hot heat exchanger and a second overhead heat exchanger on the heated rich solvent stream downstream of the first overhead heat exchanger; compressing the overhead stream in a first overhead compressor forming a first compressed overhead stream; directing the first compressed overhead stream and a first heated rich solvent stream through the second overhead heat exchanger forming a first cooled overhead stream and a second heated rich solvent stream; compressing the first cooled overhead stream in a second overhead compressor forming a second compressed overhead stream; directing the second compressed overhead stream and the heated rich solvent stream through the first overhead heat exchanger forming a second cooled overhead stream and the first heated rich solvent stream; and wherein contacting the compressed overhead stream with all or the portion of the warm rich bypass stream in the warm rich bypass overhead heat exchanger comprises contacting the second cooled overhead stream with all or the portion of the warm rich bypass stream; and wherein delivering all or a portion of the heated rich solvent stream to the stripping column comprises delivering all or a portion of the second heated rich solvent stream to the stripping column. An embodiment of the invention is one, any or all of prior embodiments in this paragraph up through the first embodiment in this paragraph further comprising heating the second heated rich solvent in a steam heater or additional heat exchanger downstream of the second overhead heat exchanger before the second heated rich solvent stream is delivered to the stripping column. An embodiment of the invention is one, any or all of prior embodiments in this paragraph up through the first embodiment in this paragraph further comprising providing an overhead heat exchanger on the heated rich solvent stream downstream of the hot heat exchanger; compressing the cooled overhead stream in a second overhead compressor forming a second compressed overhead stream; directing the second compressed overhead stream and the heated rich solvent stream through the overhead heat exchanger forming a second cooled overhead stream and a second heated rich solvent stream; and wherein delivering all or a portion of the heated rich solvent stream to the stripping column comprises delivering all or a portion of the second heated rich solvent stream to the stripping column.

A second embodiment of the invention is a process for CO₂ recovery from flue gas comprising introducing a flue gas stream and a cooled lean solvent stream into an absorber column forming a purified flue gas stream and a rich solvent stream comprising CO₂; directing the rich solvent stream through a cold heat exchanger followed by a hot heat exchanger and directing a lean solvent stream from a stripping column through the hot heat exchanger followed by the cold heat exchanger forming a first heated rich solvent stream and the cooled lean solvent stream; delivering a heated rich solvent stream to the stripping column and forming an overhead stream comprising CO₂ and the lean solvent stream; compressing the overhead stream forming a first compressed overhead stream; separating a warm rich bypass stream from the rich solvent stream downstream of the cold heat exchanger and upstream of the hot heat exchanger; directing the warm rich bypass stream to the stripping column; and directing the first heated rich solvent stream and the first compressed overhead stream through an overhead heat exchanger forming a first cooled overhead stream and a second heated rich solvent stream, the first overhead heat exchanger being downstream of the hot heat exchanger; wherein delivering the heated rich solvent stream to the stripping column comprises delivering the second heated rich solvent stream to the stripping column. An embodiment of the invention is one, any or all of prior embodiments in this paragraph up through the second embodiment in this paragraph further comprising separating a cold rich bypass stream from the rich solvent stream upstream of the cold heat exchanger and directing the cold rich bypass stream and the first cooled overhead stream to a CO₂ heat exchanger forming a heated cold rich bypass stream and a second cooled overhead stream; and directing the heated cold rich bypass stream to the stripping column. An embodiment of the invention is one, any or all of prior embodiments in this paragraph up through the second embodiment in this paragraph further comprising combining the warm rich bypass stream and the heated cold rich bypass stream; and directing the heated cold rich bypass stream to the stripping column, and directing the warm rich bypass stream to the stripping column comprises directing the combined stream to the stripping column. An embodiment of the invention is one, any or all of prior embodiments in this paragraph up through the second embodiment in this paragraph further comprising heating the second heated rich solvent in a steam heater or an additional heat exchanger downstream of the first overhead heat exchanger before the second heated rich solvent stream is delivered to the stripping column. An embodiment of the invention is one, any or all of prior embodiments in this paragraph up through the second embodiment in this paragraph further comprising providing a heat pump comprising an evaporator, a compressor, a condenser, a pressure letdown device, and a working fluid stream, the heat pump having a cycle comprising heating the working fluid stream in the evaporator, compressing the heated working fluid stream in the compressor, cooling the compressed stream in the condenser, and reducing the pressure of the cooled stream in the pressure letdown device; contacting a process stream having waste heat with the working fluid stream in the evaporator forming a cooled process stream and the heated working fluid stream; and contacting the second heated rich solvent stream with the compressed working fluid stream in the condenser of the heat pump forming a third heated rich solvent stream and the cooled working fluid stream. An embodiment of the invention is one, any or all of prior embodiments in this paragraph up through the second embodiment in this paragraph further comprising compressing the first cooled overhead stream forming a second compressed overhead stream; directing the second heated rich solvent stream and the second compressed overhead stream through a second overhead heat exchanger forming a second cooled overhead stream and a third heated rich solvent stream, the second overhead heat exchanger being downstream of the overhead heat exchanger; and wherein delivering the heated rich solvent stream to the stripping column comprises delivering the third heated rich solvent stream to the stripping column. An embodiment of the invention is one, any or all of prior embodiments in this paragraph up through the second embodiment in this paragraph further comprising separating a cold rich bypass stream from the rich solvent stream upstream of the cold heat exchanger and directing the cold rich bypass stream and the first cooled overhead stream to a CO₂ heat exchanger forming a heated cold rich bypass stream and a second cooled overhead stream; directing the heated cold rich bypass stream to the stripping column. An embodiment of the invention is one, any or all of prior embodiments in this paragraph up through the second embodiment in this paragraph further comprising combining the warm rich bypass stream and the heated cold rich bypass stream; and directing the heated cold rich bypass stream to the stripping column, and directing the warm rich bypass stream to the stripping column comprises directing the combined stream to the stripping column. An embodiment of the invention is one, any or all of prior embodiments in this paragraph up through the second embodiment in this paragraph further comprising heating the second heated rich solvent in a steam heater or an additional heat exchanger downstream of the first overhead heat exchanger before the second heated rich solvent stream is delivered to the stripping column. An embodiment of the invention is one, any or all of prior embodiments in this paragraph up through the second embodiment in this paragraph further comprising; providing a heat pump comprising an evaporator, a compressor, a condenser, a pressure letdown device, and a working fluid stream, the heat pump having a cycle comprising heating the working fluid stream in the evaporator, compressing the heated working fluid stream in the compressor, cooling the compressed stream in the condenser, and reducing the pressure of the cooled stream in the pressure letdown device; contacting a process stream having waste heat with the working fluid stream in the evaporator forming a cooled process stream and the heated working fluid stream; contacting the second heated rich solvent stream with the compressed working fluid stream in the condenser of the heat pump forming a third heated rich solvent stream and the cooled working fluid stream.

A third embodiment of the invention is an apparatus for recovering heat from an overhead stream of a stripping column in a CO₂ capture process comprising an absorber column having a flue gas inlet, a lean solvent inlet; and a rich solvent outlet; a stripping column having a first rich solvent inlet, a second rich solvent inlet, an overhead outlet, and a lean solvent outlet; a cold heat exchanger having a rich solvent inlet, a rich solvent outlet, a lean solvent inlet, and a lean solvent outlet, the rich solvent inlet of the cold heat exchanger being in downstream fluid communication with the rich solvent outlet of the absorber; a hot heat exchanger having a rich solvent inlet, a rich solvent outlet, a lean solvent inlet, and a lean solvent outlet, the rich solvent inlet of the hot heat exchanger being in downstream fluid communication with the rich solvent outlet of the cold heat exchanger, the rich solvent inlet of the stripping column being in downstream fluid communication with the rich solvent outlet of the hot heat exchanger, the lean solvent inlet of the hot heat exchanger being in downstream fluid communication with the lean solvent outlet of the stripping column, the lean solvent inlet of the cold heat exchanger being in downstream fluid communication with the lean solvent outlet of the hot heat exchanger, the lean solvent inlet of the absorber being in downstream fluid communication with the lean solvent outlet of the cold heat exchanger; a compressor having an inlet and an outlet, the compressor inlet being in fluid communication with the overhead outlet of the stripping column; and an overhead heat exchanger having an overhead inlet, an overhead outlet, a rich solvent inlet, and a rich solvent outlet, the overhead inlet of the overhead heat exchanger being in downstream fluid communication with the compressor outlet, the rich solvent inlet being in downstream fluid communication with the rich solvent outlet of the cold heat exchanger, the second rich solvent inlet of the stripping column being in downstream fluid communication with the rich solvent outlet of the overhead heat exchanger. An embodiment of the invention is one, any or all of prior embodiments in this paragraph up through the third embodiment in this paragraph wherein the overhead compressor is combined with a CO₂ product compressor and shares a common driver with the CO₂ product compressor. An embodiment of the invention is one, any or all of prior embodiments in this paragraph up through the third embodiment in this paragraph wherein the overhead compressor comprises an integrally geared centrifugal compressor. An embodiment of the invention is one, any or all of prior embodiments in this paragraph up through the third embodiment in this paragraph wherein overhead compressor comprises a double-flow inlet compressor.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for CO₂ recovery from flue gas comprising:
introducing a flue gas stream and a cooled lean solvent stream into an absorber column forming a purified flue gas stream and a rich solvent stream comprising CO₂;
directing the rich solvent stream through at least a cold heat exchanger followed by a hot heat exchanger and directing a lean solvent stream from a stripping column through the hot heat exchanger followed by the cold heat exchanger forming a heated rich solvent stream and the cooled lean solvent stream;
delivering all or a portion of the heated rich solvent stream to the stripping column and forming the lean solvent stream and an overhead stream;
compressing the overhead stream forming a compressed overhead stream;
separating a warm rich bypass stream from the rich solvent stream downstream of the cold heat exchanger and upstream of the hot heat exchanger;
contacting the compressed overhead stream with all or a portion of the warm rich bypass stream in a warm rich bypass overhead heat exchanger forming a heated warm rich bypass stream and a cooled compressed overhead stream; and
directing the heated warm rich bypass stream to the stripping column.

2. The process of claim 1 further comprising:
dividing the warm rich bypass stream into a first portion and a second portion; and
directing the second portion of the warm rich bypass stream to the stripping column.

3. The process of claim 1 further comprising:
separating a cold rich bypass stream from the rich solvent stream upstream of the cold heat exchanger and directing the cold rich bypass stream and the cooled compressed overhead stream through a CO₂ heat exchanger forming a heated cold rich bypass stream and a second cooled overhead stream; and
directing the heated cold rich bypass stream to a third point on the stripping column.

4. The process of claim 3 further comprising:
dividing the warm rich bypass stream into a first portion and a second portion;
combining the second portion of the warm rich bypass stream and the heated cold rich bypass stream forming a combined stream; and
directing the combined stream to the stripping column.

5. The process of claim 1 further comprising:
heating the heated rich solvent in a steam heater or an additional heat exchanger downstream of the hot heat exchanger before the heated rich solvent stream is delivered to the stripping column.

6. The process of claim 1 further comprising:
providing a heat pump comprising an evaporator, a compressor, a condenser, a pressure letdown device, and a working fluid stream, the heat pump having a cycle comprising heating the working fluid stream in the evaporator, compressing the heated working fluid stream in the compressor, cooling the compressed stream in the condenser, and reducing the pressure of the cooled stream in the pressure letdown device;
contacting a process stream having waste heat with the working fluid stream in the evaporator forming a cooled process stream and the heated working fluid stream; and
contacting the heated rich solvent stream with the compressed working fluid stream in the condenser of the heat pump forming a second heated rich solvent stream and the cooled working fluid stream.

7. The process of claim 1 further comprising:
providing an overhead heat exchanger on the heated rich solvent stream downstream of the hot heat exchanger;
compressing the overhead stream in a first overhead compressor forming a first compressed overhead stream;
directing the first compressed overhead stream and the heated rich solvent stream through the overhead heat exchanger forming a first cooled overhead stream and a second heated rich solvent stream; and
compressing the first cooled overhead stream in a second overhead compressor forming a second compressed overhead stream;
wherein contacting the compressed overhead stream with all or the portion of the warm rich bypass stream in the warm rich bypass overhead heat exchanger forming the heated warm rich bypass stream and the cooled compressed overhead stream comprises contacting the second compressed overhead stream with all or the portion of the warm rich bypass stream in the warm rich bypass overhead heat exchanger forming the second heated warm rich bypass stream and a second cooled compressed overhead stream; and
wherein delivering all or a portion of the heated rich solvent stream to the stripping column comprises delivering all or a portion of the second heated rich solvent stream to the stripping column.

8. The process of claim 1 further comprising:
providing a second warm rich bypass overhead heat exchanger on the heated warm rich bypass stream downstream from the warm rich bypass heat exchanger;
compressing the cooled compressed overhead stream in a second overhead compressor forming a second compressed overhead stream;
directing the second compressed overhead stream and the heated warm rich bypass solvent stream through the second warm rich bypass overhead heat exchanger forming a first cooled compressed overhead stream and a second heated warm rich bypass solvent stream; and
wherein directing the heated warm rich bypass stream to the stripping column comprises directing the second heated warm rich bypass stream to the stripping column.

9. The process of claim 1 further comprising:
combining the heated warm rich bypass stream and the heated rich solvent stream forming a combined stream; and
wherein delivering all or a portion of the heated rich solvent stream to the stripping column and directing the heated warm rich bypass stream to the stripping column comprises directing the combined stream to the stripping column.

10. The process of claim 1 further comprising:
compressing the cooled compressed overhead stream in a second overhead compressor forming a second compressed overhead stream;
contacting the second compressed overhead stream with the heated rich solvent stream in an additional heat exchanger on the heated rich solvent stream, the additional heat exchanger being downstream of the hot heat exchanger forming a second heated rich solvent stream and a second cooled compressed overhead stream; and
wherein delivering all or a portion of the heated rich solvent stream to the stripping column comprises delivering all or a portion of the second heated rich solvent stream to the stripping column.

11. A process for CO₂ recovery from flue gas comprising:
introducing a flue gas stream and a cooled lean solvent stream into an absorber column forming a purified flue gas stream and a rich solvent stream comprising CO₂;
directing the rich solvent stream through a cold heat exchanger followed by a hot heat exchanger and directing a lean solvent stream from a stripping column through the hot heat exchanger followed by the cold heat exchanger forming a first heated rich solvent stream and the cooled lean solvent stream;
delivering a heated rich solvent stream to the stripping column and forming an overhead stream comprising CO₂ and the lean solvent stream;
compressing the overhead stream forming a first compressed overhead stream;
separating a warm rich bypass stream from the rich solvent stream downstream of the cold heat exchanger and upstream of the hot heat exchanger;
directing the warm rich bypass stream to the stripping column; and
directing the first heated rich solvent stream and the first compressed overhead stream through an overhead heat exchanger forming a first cooled overhead stream and a second heated rich solvent stream, the first overhead heat exchanger being downstream of the hot heat exchanger;
wherein delivering the heated rich solvent stream to the stripping column comprises delivering the second heated rich solvent stream to the stripping column.

12. The process of claim 11 further comprising:
separating a cold rich bypass stream from the rich solvent stream upstream of the cold heat exchanger and directing the cold rich bypass stream and the first cooled overhead stream to a CO₂ heat exchanger forming a heated cold rich bypass stream and a second cooled overhead stream; and
directing the heated cold rich bypass stream to the stripping column.

13. The process of claim 12 further comprising:
combining the warm rich bypass stream and the heated cold rich bypass stream; and
directing the heated cold rich bypass stream to the stripping column, and directing the warm rich bypass stream to the stripping column comprises directing the combined stream to the stripping column.

14. The process of claim 11 further comprising:
heating the second heated rich solvent in a steam heater or an additional heat exchanger downstream of the first overhead heat exchanger before the second heated rich solvent stream is delivered to the stripping column.

15. The process of claim 11 further comprising:
providing a heat pump comprising an evaporator, a compressor, a condenser, a pressure letdown device, and a working fluid stream, the heat pump having a cycle comprising heating the working fluid stream in the evaporator, compressing the heated working fluid stream in the compressor, cooling the compressed stream in the condenser, and reducing the pressure of the cooled stream in the pressure letdown device;
contacting a process stream having waste heat with the working fluid stream in the evaporator forming a cooled process stream and the heated working fluid stream; and
contacting the second heated rich solvent stream with the compressed working fluid stream in the condenser of the heat pump forming a third heated rich solvent stream and the cooled working fluid stream.

16. The process of claim 11 further comprising:
compressing the first cooled overhead stream forming a second compressed overhead stream; and
directing the second heated rich solvent stream and the second compressed overhead stream through a second overhead heat exchanger forming a second cooled overhead stream and a third heated rich solvent stream, the second overhead heat exchanger being downstream of the overhead heat exchanger;
wherein delivering the heated rich solvent stream to the stripping column comprises delivering the third heated rich solvent stream to the stripping column.

17. An apparatus for recovering heat from an overhead stream of a stripping column in a CO₂ capture process comprising:
an absorber column having a flue gas inlet, a lean solvent inlet; and a rich solvent outlet;
a stripping column having a first rich solvent inlet, a second rich solvent inlet, an overhead outlet, and a lean solvent outlet;
a cold heat exchanger having a rich solvent inlet, a rich solvent outlet, a lean solvent inlet, and a lean solvent outlet, the rich solvent inlet of the cold heat exchanger being in downstream fluid communication with the rich solvent outlet of the absorber;
a hot heat exchanger having a rich solvent inlet, a rich solvent outlet, a lean solvent inlet, and a lean solvent outlet, the rich solvent inlet of the hot heat exchanger being in downstream fluid communication with the rich solvent outlet of the cold heat exchanger, the rich solvent inlet of the stripping column being in downstream fluid communication with the rich solvent outlet of the hot heat exchanger, the lean solvent inlet of the hot heat exchanger being in downstream fluid communication with the lean solvent outlet of the stripping column, the lean solvent inlet of the cold heat exchanger being in downstream fluid communication with the lean solvent outlet of the hot heat exchanger, the lean solvent inlet of the absorber being in downstream fluid communication with the lean solvent outlet of the cold heat exchanger;
a compressor having an inlet and an outlet, the compressor inlet being in fluid communication with the overhead outlet of the stripping column; and
an overhead heat exchanger having an overhead inlet, an overhead outlet, a rich solvent inlet, and a rich solvent outlet, the overhead inlet of the overhead heat exchanger being in downstream fluid communication with the compressor outlet, the rich solvent inlet being in downstream fluid communication with the rich solvent outlet of the cold heat exchanger, the second rich solvent inlet of the stripping column being in downstream fluid communication with the rich solvent outlet of the overhead heat exchanger.

18. The apparatus of claim 17 wherein the overhead compressor is combined with a CO₂ product compressor and shares a common driver with the CO₂ product compressor.

19. The apparatus of claim 17 wherein the overhead compressor comprises an integrally geared centrifugal compressor.

20. The apparatus of claim 17 wherein overhead compressor comprises a double-flow inlet compressor.
